(19) United States
(12) Patent Application Publication
(10) Pub. No.: US 2018/0137521 A1
(43) Pub. Date: May 17, 2018

(54) CONSUMER BEHAVIOR-BASED DYNAMIC PRODUCT PRICING TARGETING

(71) Applicant: b8ta, inc., San Francisco, CA (US)

(72) Inventors: Vibhu Norby, Mountain View, CA (US); William Mintun, Aptos, CA (US); Phillip Raub, San Francisco, CA (US); Nicholas Mann, San Jose, CA (US)

(73) Assignee: b8ta, inc., San Francisco, CA (US)

(21) Appl. No.: 15/352,269

(22) Filed: Nov. 15, 2016

(51) Int. Cl. G06Q 30/02

(52) U.S. Cl. CPC G06Q 30/0201; G06Q 30/0283

(57) ABSTRACT

Techniques for targeting consumers using consumer behavior-based dynamic product pricing. A system utilizing such techniques can include a consumer interaction monitoring system and a consumer behavior-based dynamic product pricing offering system. A method utilizing such techniques can include monitoring behaviors of a consumer in interacting online and offering consumers products at consumer behavior-based product prices determined based on the monitored behaviors.

### BRIEF DESCRIPTION OF THE DRAWINGS

FIG. 1 depicts a diagram of an example of a system for facilitating behavior-based dynamic product pricing consumer targeting.

FIG. 2 depicts a flowchart of an example of a method for targeting consumers using consumer behavior-based dynamic product pricing.

FIG. 3 depicts a diagram of an example of a consumer interaction monitoring system.

FIG. 4 depicts a flowchart of an example of a method for tracking consumer behaviors for use in targeting a consumer using consumer behavior-based dynamic product pricing.

FIG. 5 depicts a diagram of an example of a consumer behavior-based dynamic product pricing rules management system.

FIG. 6 depicts a flowchart of an example of a method for maintaining consumer behavior-based dynamic product pricing rules for use in targeting consumers using consumer behavior-based dynamic product pricing.

FIG. 7 depicts a diagram of an example consumer behavior-based dynamic product pricing offering system.

FIG. 8 depicts a flowchart of an example of a method of presenting consumer behavior-based product prices of products determined according to consumer behavior-based dynamic product pricing rules to a consumer.

FIG. 9 depicts a flowchart of an example of a method for targeting a consumer using consumer behavior-based dynamic product pricing.

### DETAILED DESCRIPTION

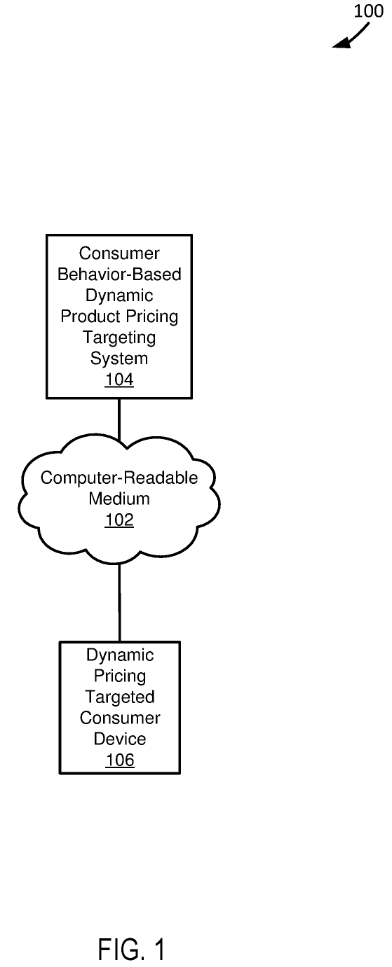

FIG. 1 depicts a diagram 100 of an example of a system for facilitating behavior-based dynamic product pricing consumer targeting. The system of the example of FIG. 1 includes a computer-readable medium 102, a consumer behavior-based dynamic product pricing targeting system 104, and a dynamic pricing targeted consumer device 106.

The computer-readable medium 102 and other computer readable mediums discussed in this paper are intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

The computer-readable medium 102 and other computer readable mediums discussed in this paper are intended to represent a variety of potentially applicable technologies. For example, the computer-readable medium 102 can be used to form a network or part of a network. Where two components are co-located on a device, the computer-readable medium 102 can include a bus or other data conduit or plane. Where a first component is co-located on one device and a second component is located on a different device, the computer-readable medium 102 can include a wireless or wired back-end network or LAN. The computer-readable medium 102 can also encompass a relevant portion of a WAN or other network, if applicable.

The devices, systems, and computer-readable mediums described in this paper can be implemented as a computer system or parts of a computer system or a plurality of computer systems. In general, a computer system will include a processor, memory, non-volatile storage, and an interface. A typical computer system will usually include at least a processor, memory, and a device (e.g., a bus) coupling the memory to the processor. The processor can be, for example, a general-purpose central processing unit (CPU), such as a microprocessor, or a special-purpose processor, such as a microcontroller.

The memory can include, by way of example but not limitation, random access memory (RAM), such as dynamic RAM (DRAM) and static RAM (SRAM). The memory can be local, remote, or distributed. The bus can also couple the processor to non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at an applicable known or convenient location (from non-volatile storage to hardware registers) when the software program is referred to as “implemented in a computer-readable storage medium.” A processor is considered to be “configured to execute a program” when at least one value associated with the program is stored in a register readable by the processor.

In one example of operation, a computer system can be controlled by operating system software, which is a software program that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus can also couple the processor to the interface. The interface can include one or more input and/or output (I/O) devices. Depending upon implementation-specific or other considerations, the I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device. The interface can include one or more of a modem or network interface. It will be appreciated that a modem or network interface can be considered to be part of the computer system. The interface can include an analog modem, ISDN modem, cable modem, token ring interface, satellite transmission interface (e.g. “direct PC”), or other interfaces for coupling a computer system to other computer systems. Interfaces enable computer systems and other devices to be coupled together in a network.

The computer systems can be compatible with or implemented as part of or through a cloud-based computing system. As used in this paper, a cloud-based computing system is a system that provides virtualized computing resources, software and/or information to end user devices. The computing resources, software and/or information can be virtualized by maintaining centralized services and resources that the edge devices can access over a communication interface, such as a network. “Cloud” may be a marketing term and for the purposes of this paper can include any of the networks described herein. The cloud-based computing system can involve a subscription for services or use a utility pricing model. Users can access the protocols of the cloud-based computing system through a web browser or other container application located on their end user device.

A computer system can be implemented as an engine, as part of an engine or through multiple engines. As used in this paper, an engine includes one or more processors or a portion thereof. A portion of one or more processors can include some portion of hardware less than all of the hardware comprising any given one or more processors, such as a subset of registers, the portion of the processor dedicated to one or more threads of a multi-threaded processor, a time slice during which the processor is wholly or partially dedicated to carrying out part of the engine's functionality, or the like. As such, a first engine and a second engine can have one or more dedicated processors or a first engine and a second engine can share one or more processors with one another or other engines. Depending upon implementation-specific or other considerations, an engine can be centralized or its functionality distributed. An engine can include hardware, firmware, or software embodied in a computer-readable medium for execution by the processor. The processor transforms data into new data using implemented data structures and methods, such as is described with reference to the FIGS. in this paper.

The engines described in this paper, or the engines through which the systems and devices described in this paper can be implemented, can be cloud-based engines. As used in this paper, a cloud-based engine is an engine that can run applications and/or functionalities using a cloud-based computing system. All or portions of the applications and/or functionalities can be distributed across multiple computing devices, and need not be restricted to only one computing device. In some embodiments, the cloud-based engines can execute functionalities and/or modules that end users access through a web browser or container application without having the functionalities and/or modules installed locally on the end-users' computing devices.

As used in this paper, datastores are intended to include repositories having any applicable organization of data, including tables, comma-separated values (CSV) files, traditional databases (e.g., SQL), or other applicable known or convenient organizational formats. Datastores can be implemented, for example, as software embodied in a physical computer-readable medium on a specific-purpose machine, in firmware, in hardware, in a combination thereof, or in an applicable known or convenient device or system. Datastore-associated components, such as database interfaces, can be considered “part of” a datastore, part of some other system component, or a combination thereof, though the physical location and other characteristics of datastore-associated components is not critical for an understanding of the techniques described in this paper.

Datastores can include data structures. As used in this paper, a data structure is associated with a particular way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus, some data structures are based on computing the addresses of data items with arithmetic operations; while other data structures are based on storing addresses of data items within the structure itself. Many data structures use both principles, sometimes combined in non-trivial ways. The implementation of a data structure usually entails writing a set of procedures that create and manipulate instances of that structure. The datastores, described in this paper, can be cloud-based datastores. A cloud-based datastore is a datastore that is compatible with cloud-based computing systems and engines.

Returning to the example of FIG. 1, the consumer behavior-based dynamic product pricing targeting system 104 is intended to represent a system that facilitates targeting of consumers using consumer behavior-based dynamic product pricing. Consumer behavior-based dynamic product pricing is dynamic in that consumer behavior-based product prices offered to users can vary between users or groups of users. For example, a first user at a physical retail location can be offered a product at a first consumer behavior-based price while at the physical retail location, while a second user at the physical retail location can be offered the product at a second consumer-behavior based price different from the first consumer behavior-based price offered to the first user. Consumer behavior-based product prices offered to consumers can be dynamic in that they vary based on whether a consumer is shopping at a physical retail location or through an online retailer. For example, a first user can be offered a product at a first consumer behavior-based price when shopping at a physical retail location selling the product, while the same user can be offered the product at a different consumer behavior-based price when shopping at an online retailer selling the product. An online retailer can be an online marketplace provided by the same entity providing a physical retail location.

In a specific implementation, variety amongst consumer behavior-based dynamic pricing of a product is achieved by offering the product at a varying consumer behavior-based product discount. For example, a first consumer behavior-based product discount can be offered to a consumer in a group of consumers and a different consumer behavior-based product discount can be offered to another consumer in a different group of consumers. In another example, a first consumer behavior-based product discount can be offered to a consumer when the consumer is shopping at a physical retail location while a different consumer behavior-based product discount can be offered to the same consumer for use when the consumer is shopping through an online retailer.

In targeting consumers through consumer behavior-based dynamic product pricing, the consumer behavior-based dynamic product pricing targeting system 104 functions to select a specific consumer behavior-based product price of a dynamic consumer behavior-based product price to offer to a consumer. For example, the consumer behavior-based dynamic product pricing targeting system 104 can select whether to offer a 20% or a 10% consumer behavior-based discount for a product. Further, in targeting consumers through consumer behavior-based dynamic product pricing, the consumer behavior-based dynamic product pricing targeting system 104 can actually offer to a consumer a product at a selected consumer behavior-based product price of a dynamic consumer behavior-based product price of the product. The consumer behavior-based dynamic product pricing targeting system 104 can target specific consumers using consumer behavior-based dynamic product pricing based on consumer behaviors of the consumers. For example, the consumer behavior-based dynamic product pricing targeting system 104 can select to offer a product to a consumer at a 20% discount and subsequently offer the product to the consumer at the 20% discount based on behaviors of the consumer.

In a specific implementation, the consumer behavior-based dynamic product pricing targeting system 104 functions to target consumers using consumer behavior-based dynamic product pricing of products sold through flash retailing. Flash retailing, otherwise referred to as selling a product according to a flash retailing model, includes renting space or securing a right to sell at a facility, a physical retail location, for purposes of selling products on a temporary or rented basis. Flash retailing also includes aspects of subsequent selling of a product through the facility. Flash retailing can include renting space of at a facility by a product developer or manufacturer who is independent from the facility for purposes of selling a product at the facility. For example, flash retailing can include different product developers renting space at a facility to sell their products. Further in the example, flash retailing can include different product developers renting space at a retail facility location for, at least a temporary basis, for selling the different products autonomously from each other while still occupying, at least in part, the same retail facility location. Through the use of flash retailing, a product developer or manufacturer can secure space at a physical retail location to sell their product without having to invest overhead in renting and setting up an entire retail location by themselves.

In a specific implementation, flash retailing includes reserving a right to sell a product through a retailer system and the subsequent selling of the product through the retailer system. For example, flash retailing can include a product developer independent of a retailer system reserving the right to sell a product through a retailer system and the actual sale of the product through the retailer system. A retailer system can include an online store of a retailer and flash retailing can include a manufacturer or product developer separate from the retailer offering a product and potentially actually selling the product through the online store.

In a specific implementation, the consumer behavior-based dynamic product pricing targeting system 104 functions to target consumers using consumer behavior-based dynamic product pricing according to market segmentation variables. Specifically, the consumer behavior-based dynamic product pricing targeting system 104 can select a consumer behavior-based product price at which to offer a product to a consumer and subsequently offer the product at the price to the consumer based on values of market segmentation variables of the consumer. Market segmentation variables include applicable demographic, geographic, psychographic, and behavioristic variables for segmenting people into market groups. For example, values of market segmentation variables can include an age and sex of a consumer. Market groups, as used in this paper, can include one or a plurality of consumers. Market groups in which a user is segmented and values of market segmentation variables can be included as part of a consumer profile for a consumer.

In a specific implementation, the consumer behavior-based dynamic product pricing targeting system 104 functions to monitor behaviors of a consumer in interacting online, e.g. when shopping through an online retailer or viewing products through a product developer webpage. In monitoring behaviors of a consumer in interacting online, the consumer behavior-based dynamic product pricing targeting system 104 can determine applicable behaviors of the consumer in accessing online network services. Example applicable behaviors of a consumer in accessing online network services include products a consumer viewed online, e.g. through an online retailer, products the consumer purchased online, specific websites, systems, and hosts a consumer accessed online, prices of products offered to a consumer online, and products suggested and presented to a consumer online. For example, applicable behaviors of a consumer in accessing online network services can include specific televisions a consumer viewed through an online retailer. Further in the example, applicable behaviors of the consumer in accessing online network services can include prices of the specific televisions offered to the consumer through the online retailer. Monitored behaviors of a consumer in interacting online can be included as part of a consumer profile for the consumer.

In a specific implementation, the consumer behavior-based dynamic product pricing targeting system 104 functions to monitor behaviors of a consumer in interacting online while the consumer is at a physical retail location. In monitoring behaviors of a consumer in interaction online while the consumer is at a physical retail location, the consumer behavior-based dynamic product pricing targeting system 104 can monitor behaviors of the consumer in browsing online through a network provided at the physical retail location. For example, the consumer behavior-based dynamic product pricing targeting system 104 can track behaviors of a consumer in accessing an online retailer at a physical retail location through a wireless network provided at the physical retail location.

In a specific implementation, the consumer behavior-based dynamic product pricing targeting system 104 functions to monitor behaviors of a consumer in interacting with a physical retail location. Example behaviors of a consumer in interacting with a physical retail location include products a consumer interacted with at the location, how a consumer interacted with products at the location, sales people a consumer spoke with at the location, areas at the physical location a consumer occupied, traffic patterns of a consumer in moving around the location, advertisements a consumer viewed at the location, products a consumer expressed interest in at the location, and products a consumer purchased at the location. For example, behaviors of a consumer in interacting with a physical retail location can include that a consumer viewed an advertisement for a specific product three times on a display at the location. In another example, behaviors of a consumer in interacting with a physical retail location can include specific products the consumer viewed demonstrations of at the physical retail location. Monitored behaviors of a consumer in interacting with a physical retail location can be included as part of a consumer profile.

In a specific implementation, the consumer behavior-based dynamic product pricing targeting system 104 functions to maintain consumer profiles for use in targeting consumers using consumer behavior-based dynamic product pricing. The consumer behavior-based dynamic product pricing targeting system 104 can maintain consumer profiles to indicate characteristics of consumers. Characteristics of consumers can include one or a combination of values of market segment variable for consumers, market groups users have been segmented into, monitored behaviors of consumers in interacting online, and monitored behaviors of consumers in interacting with a physical retail location. For example, the consumer behavior-based dynamic product pricing targeting system 104 can maintain a consumer profile for a consumer to indicate products the consumer views at a physical retail location.

In a specific implementation, the consumer behavior-based dynamic product pricing targeting system 104 functions to maintain consumer behavior-based dynamic product pricing rules. Consumer behavior-based dynamic product pricing rules can be used by the consumer behavior-based dynamic product pricing targeting system 104 to target consumers using consumer behavior-based dynamic product pricing. Specifically, consumer behavior-based dynamic product pricing rules include maps of characteristics of consumers, as indicated by consumer profiles, to specific rules for determining a consumer behavior-based product price of a dynamic consumer behavior-based product price to offer to a consumer. For example, a consumer behavior-based dynamic product pricing rule can specify that if a consumer viewed a product through an online retailer, then offer the product to the consumer at a physical retail location at a 10% discount. In another example, a consumer behavior-based dynamic product pricing rule can specify that if a consumer is comparing first and second competing products, then offer the first product to the consumer at a 20% discount. The consumer behavior-based dynamic product pricing targeting system 104 can apply machine learning to buying patterns of consumers and characteristics of the consumers in maintaining consumer behavior-based dynamic product pricing rules.

In a specific implementation, consumer behavior-based dynamic product pricing rules include rules for retargeting a consumer using consumer behavior-based dynamic product pricing. Consumer behavior-based dynamic product pricing rules for retargeting a consumer, as maintained by the consumer behavior-based dynamic product pricing targeting system 104, can specify times when to retarget a consumer, platforms to use in retargeting a consumer, and rules for determining consumer behavior-based product prices to offer a consumer in retargeting the consumer. For example, consumer behavior-based dynamic product pricing rules for retargeting a consumer can specify that if a consumer viewed a specific product at a physical retail location but did not purchase it, then offer an 8% discount on the product to the consumer one day later through an online retailer. In another example, consumer behavior-based dynamic product pricing rules for retargeting a consumer can specify that if a consumer viewed a specific product at a physical retail location but did not purchase it, then offer an 8% discount on the product to the consumer when the consumer visits the physical retail location again.

In a specific implementation, the consumer behavior-based dynamic product pricing targeting system 104 functions to maintain consumer behavior-based dynamic product pricing rules according to likelihoods of a consumer in buying a product offered to them. The consumer behavior-based dynamic product pricing targeting system 104 can maintain consumer behavior-based dynamic product pricing rules according to likelihoods of a consumer in buying a product offered to them and characteristics of the consumer. For example, if a consumer, as indicated by their characteristics, has no prior knowledge of a product before arriving at a physical retail location then rules can specify offering the consumer a lower price for the product then a consumer who is more informed about the product. The consumer behavior-based dynamic product pricing targeting system 104 can maintain rules specifying to offer a product to consumers at prices inversely proportional to likelihoods of consumers to buy the product. For example, if a first consumer is more likely to buy a product than a second consumer, then consumer behavior-based dynamic product pricing rules can specify to offer a 20% discount on the product to the second consumer and a 10% discount on the product to the first consumer.

In a specific implementation, the consumer behavior-based dynamic product pricing targeting system 104 functions to maintain consumer behavior-based dynamic product pricing rules based on familiarity levels of consumers with a product. Familiarity levels of consumer with a product include measures of how aware a consumer is. Familiarity levels of a consumer with a product can be determined from characteristics of the consumer. In particular, familiarity levels of a consumer with a product can be determined based on behaviors of a consumer in interacting with either or both an online retailer and a physical retail location. For example, if a consumer viewed a product before at an online retailer, then it can be determined the consumer is very familiar with the product and is therefore a shopper of the specific product. In another example, if a consumer viewed a plurality of products including a specific product while visiting a physical retail location, then it can be determined the consumer is mildly familiar with the specific product and is therefore an informed shopper with respect to the specific product. Examples of consumer behavior-based dynamic product pricing rules based on consumer familiarity levels include: offering a 20% discount to a completely uninformed shopper, offering a 14% discount to a shopper who is an informed shopper, e.g. mildly familiar with a product, and offering an 8% discount to a shopper who is a shopper of a specific product, e.g. very informed about the specific product.

In a specific implementation, the consumer behavior-based dynamic product pricing targeting system 104 functions to maintain consumer behavior-based dynamic product pricing rules according to likelihoods of a consumer in buying a product offered to them through consumer behavior-based dynamic product pricing. In being maintained according to likelihoods of a consumer buying a product offered through consumer behavior-based dynamic product pricing, consumer behavior-based dynamic product pricing rules can specify to give a specific discount to consumers with specific consumer characteristics if there is a specific chance the consumers will buy a product at the specific discount. For example, if informed shoppers to a product are 50% more likely to buy the product when offered a 14% discount, then consumer behavior-based dynamic product pricing rules can specify offering a 14% discount to consumers with consumer characteristics indicating they are informed shoppers for the product.

In a specific implementation, the consumer behavior-based dynamic product pricing targeting system 104 functions to maintain consumer behavior-based dynamic product pricing rules based on input from a product supplier or developer. In maintaining rules based on input from a product supplier or developer, the consumer behavior-based dynamic product pricing targeting system 104 can receive input instructing specific prices of a product to offer to consumers with specific characteristics, and the consumer behavior-based dynamic product pricing targeting system 104 can subsequently create consumer behavior-based dynamic product pricing rules based on such input. For example, if product developer input indicates offering a 20% discount on a product to uninformed consumers to drive product conversion, then the consumer behavior-based dynamic product pricing targeting system 104 can generate a dynamic product pricing rule to indicate offering the product at a 20% discount to uninformed consumers, as indicated by characteristics of the consumers.

In a specific implementation, the consumer behavior-based dynamic product pricing targeting system 104 functions to gain approval for maintained consumer behavior-based dynamic product pricing rules before or during implementation of the rules to target consumers using consumer behavior-based dynamic product pricing. For example, if the consumer behavior-based dynamic product pricing targeting system 104 determines to offer an 8% discount to informed shoppers of a specific product, e.g. based on behaviors of consumers and measures of actual conversion of the specific product, then the consumer behavior-based dynamic product pricing targeting system 104 can seek approval to offer the discount from a product developer of the specific product. Further in the example, the product developer can provide input indicating whether they agree to offering of the discount, and the consumer behavior-based dynamic product pricing targeting system 104 can subsequently create and implement consumer behavior-based dynamic product pricing rules indicating to offer the discount to informed shoppers of the product.

In a specific implementation, consumer behavior-based dynamic product pricing rules maintained by the consumer behavior-based dynamic product pricing targeting system 104 specify to offer a specific consumer behavior-based product price to multiple consumers simultaneously. Specifically, consumer behavior-based dynamic product pricing rules can specify to offer a product at a specific consumer behavior-based product price to a plurality of consumers at a physical retail location. For example, according to consumer behavior-based dynamic product pricing rules, the consumer behavior-based dynamic product pricing targeting system 104 can offer a product at a specific price to a first consumer at a physical retail location based on characteristics of the consumer and offer a second consumer at the physical retail location the product at the specific price regardless of the characteristics of the second consumer.

In a specific implementation, consumer behavior-based dynamic product pricing rules maintained by the consumer behavior-based dynamic product pricing targeting system 104 specify to randomly offer a consumers discounts on products. For example, consumer behavior-based dynamic product pricing rules can specify to randomly offer one customer a discount on a product at a physical retail location. Consumer behavior-based dynamic product pricing rules specifying to randomly offer a discount to products can be time sensitive. For example, consumer behavior-based dynamic product pricing rules can specify to randomly offer a discount to a product that expires if the consumer does not buy the product within twenty-four hours.

In a specific implementation, the consumer behavior-based dynamic product pricing targeting system 104 functions to target consumers using consumer behavior-based dynamic product pricing according to consumer profiles. In targeting consumers according to consumer profiles, the consumer behavior-based dynamic product pricing targeting system 104 can select specific consumer behavior-based dynamic pricing rules to apply in targeting the consumers based on the consumer profiles of the consumers. For example, if a consumer profile indicates specific characteristics of a consumer and specific consumer behavior-based dynamic pricing rules are mapped to the specific characteristics, then the consumer behavior-based dynamic product pricing targeting system 104 can target the consumer according to the specific consumer behavior-based dynamic pricing rules. Further, in targeting consumers according to consumer profiles, the consumer behavior-based dynamic product pricing targeting system 104 can determine consumer behavior-product prices at which to offer products to consumers according to rules selected based on consumer profiles. For example, if selected rules, based on a consumer profile of a consumer, indicate offering a 20% discount for a specific product, then the consumer behavior-based dynamic product pricing targeting system 104 can determine to offer the product to the consumer at the 20% discount and subsequently offer the product to the consumer at the discount.

In a specific implementation, the consumer behavior-based dynamic product pricing targeting system 104 functions to target consumers using consumer behavior based dynamic product pricing according to monitored behaviors of a consumer in interacting online. In targeting consumers according to monitored behaviors of a consumer in interacting online, the consumer behavior-based dynamic product pricing targeting system 104 can select consumer behavior-based dynamic product pricing rules to use based on the monitored behaviors of the consumer in interacting online. Further, in targeting consumers according to monitored behaviors of a consumer in interacting with an online retailer, the consumer behavior-based dynamic product pricing targeting system 104 can actually target the consumer according to rules selected based on the monitored behaviors of the consumer in interacting online.

In a specific implementation, the consumer behavior-based dynamic product pricing targeting system 104 functions to target consumers using consumer behavior based dynamic product pricing according to monitored behaviors of a consumer in interacting with a physical retail location. In targeting consumers according to monitored behaviors of a consumer in interacting with a physical retail location, the consumer behavior-based dynamic product pricing targeting system 104 can select consumer behavior-based dynamic product pricing rules to use based on the monitored behaviors of the consumer in interacting with the physical retail location. Further, in targeting consumers according to monitored behaviors of a consumer in interacting online, the consumer behavior-based dynamic product pricing targeting system 104 can actually target the consumer according to rules selected based on the monitored behaviors of the consumer in interacting with a physical retail location.

In a specific implementation, the consumer behavior-based dynamic product pricing targeting system 104 functions to target a consumer using one or a combination of a consumer device of the consumer and an applicable device at a physical retail location. For example, the consumer behavior-based dynamic product pricing targeting system 104 can present determined offers to a user using an advertisement display at a physical retail location, or a consumer device of the consumer accessing network services at the physical retail location. In a specific implementation, the consumer behavior-based dynamic product pricing targeting system 104 can target a consumer when either or both when the consumer is at a physical retail location and the consumer is interacting online. For example, the consumer behavior-based dynamic product pricing targeting system 104 can target a consumer when the consumer is accessing an online retailer associated with a physical retail location while the consumer is remote from the physical retail location.

In a specific implementation, the consumer behavior-based dynamic product pricing targeting system 104 functions to set expiration times for consumer behavior-based product prices offered to consumers. The consumer behavior-based dynamic product pricing targeting system 104 can set expiration times for consumer behavior-based product prices offered to consumers according to consumer behavior-based dynamic product pricing rules. For example, if consumer behavior-based dynamic product pricing rules specify an offer for a product should expire when a consumer buys a similar or competing product, then the consumer behavior-based dynamic product pricing targeting system 104 can set an expiration time for an offer for the product at when the consumer buys a similar product. Expiration times for offers set by the consumer behavior-based dynamic product pricing targeting system 104 can be dependent on behaviors of a consumer. For example, the consumer behavior-based dynamic product pricing targeting system 104 can set an expiration time for an offer at a time when a consumer leaves a physical retail location.

In a specific implementation, the consumer behavior-based dynamic product pricing targeting system 104 functions to retarget a consumer using consumer behavior-based dynamic product pricing. The consumer behavior-based dynamic product pricing targeting system 104 can retarget a consumer according to consumer behavior-based dynamic product pricing rules. In retargeting a consumer, the consumer behavior-based dynamic product pricing targeting system 104 can reoffer a previously offered consumer behavior-based product price to a consumer. For example, if a consumer was offered a discount of 20% on a product while at a physical retail location, then the consumer behavior-based dynamic product pricing targeting system 104 can reoffer the 20% discount to the consumer after the consumer leaves the physical retail location. Additionally, in retargeting a consumer, the consumer behavior-based dynamic product pricing targeting system 104 can determine a new price of a product to offer to a consumer after offering the consumer the product at a previous price. For example, if a product was previously offered at a 10% discount to a consumer, and the consumer did not accept the offer, then the consumer behavior-based dynamic product pricing targeting system 104 can retarget the consumer and offer the product at a 20% discount.

In a specific implementation, the consumer behavior-based dynamic product pricing targeting system 104 is implemented, at least in part, on one or a combination of a consumer device, a facility device, and a facility operator device, e.g. a salesperson at a physical retail location. For example, the consumer behavior-based dynamic product pricing targeting system 104 can be implemented as an application executing at a consumer device configured to present offered consumer behavior-based product prices to a consumer. In another example, the consumer behavior-based dynamic product pricing targeting system is implemented as or part of a payment application on a facility operator device and is used to complete product conversion at a physical retail location according to offered consumer behavior-based product prices.

Referring back to FIG. 1, the dynamic pricing targeted consumer device 106 is intended to represent a device of a consumer used in facilitating targeting of the consumer through consumer behavior-based dynamic product pricing. Using the dynamic pricing targeted consumer device 106, behaviors of a consumer in interacting online can be determined. For example, if a consumer uses the dynamic pricing targeted consumer device 106 to access an online retailer, then the behaviors of the consumer in interacting with the online retailer can be determined by tracking interactions of the consumer with the online retailer at the dynamic pricing targeted consumer device 106. Additionally, using the dynamic pricing targeted consumer device 106, behaviors of a consumer in interacting at a physical retail location can be monitored. For example, if a consumer accesses data about a specific product while at the physical retail location using the dynamic pricing targeted consumer device 106, then it can be determined based on such data access that the consumer is interested in the specific product at the physical retail location.

In a specific implementation, the dynamic pricing targeted consumer device 106 functions to present offered product prices to a consumer as part of targeting the consumer using consumer behavior-based dynamic product pricing. For example, the dynamic pricing targeted consumer device 106 can be used to present an offered consumer behavior-based product price to a consumer through an online retailer accessed using the dynamic pricing targeted consumer device 106. In another example, the dynamic pricing targeted consumer device 106 can be used to present an offered consumer behavior-based price of a product to a consumer when the consumer is at a physical retail location selling the product.

In an example of operation of the example system shown in FIG. 1, the consumer behavior-based dynamic product pricing targeting system 104 maintains consumer behavior-based dynamic product pricing rules for use in targeting a consumer using consumer behavior-based dynamic product pricing. In the example of operation of the example system shown in FIG. 1, the consumer behavior-based dynamic product pricing targeting system 104 profiles the consumer by maintaining a consumer profile indicating consumer characteristics of the consumer based on the consumer's utilization of the dynamic pricing targeted consumer device 106. Further, in the example of operation of the example system shown in FIG. 1, the consumer behavior-based dynamic product pricing targeting system 104 determines a consumer behavior-based product price at which to offer a specific product to the consumer based on the characteristics of the consumer and the consumer behavior-based dynamic product pricing rules. In the example of operation of the example system shown in FIG. 1, the dynamic pricing targeted consumer device 106 displays the determined consumer behavior-based product price to the product as part of offering the product at the price for use in facilitating sale of the product to the consumer at the price.

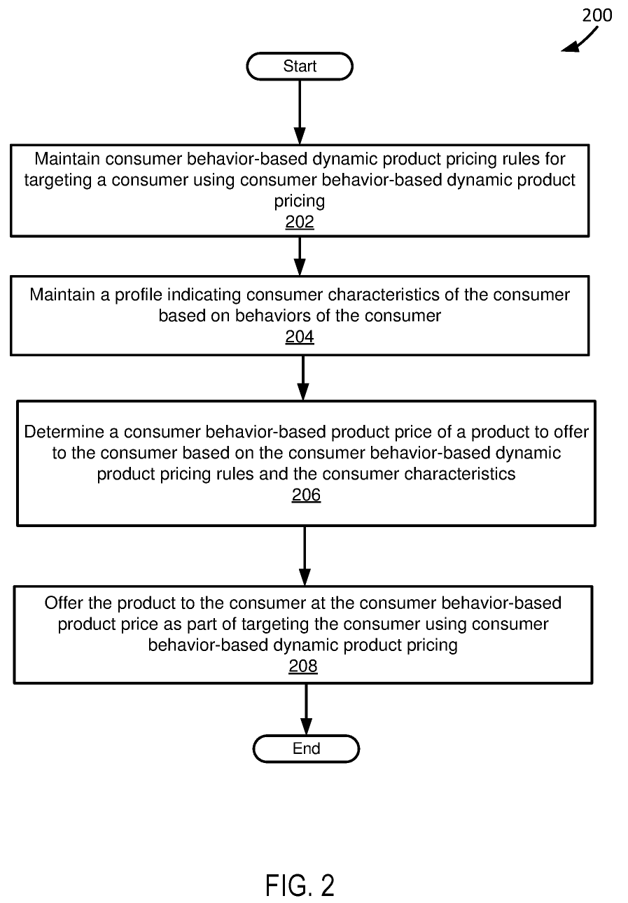

FIG. 2 depicts a flowchart 200 of an example of a method for targeting consumers using consumer behavior-based dynamic product pricing. The flowchart 200 begins at module 202, where consumer behavior-based dynamic product pricing rules for targeting a consumer using consumer behavior-based dynamic product pricing are maintained. An applicable system for targeting consumers using consumer behavior-based dynamic product pricing, such as the consumer behavior-based dynamic product pricing targeting systems described in this paper, can maintain consumer behavior-based dynamic product pricing rules. Consumer behavior-based dynamic product pricing rules can be maintained based on buying patterns of consumers and characteristics of the consumers. For example, if women between the ages of 20 and 25 are more likely to purchase a specific product offered at a 10% discount, as indicating by buying patterns of consumers and characteristics of the consumers, then a rule can be maintained indicating to offer a 10% discount on the specific product to women between the ages of 20 and 25.

The flowchart 200 continues to module 204, where a profile indicating characteristics of the consumer is maintained based on behaviors of the consumer. An applicable system for targeting consumers using consumer behavior-based dynamic product pricing, such as the consumer behavior-based dynamic product pricing targeting systems described in this paper, can maintain a profile indicating consumer characteristics of the consumer based on behaviors of the consumer. A profile indicating characteristics of the consumer can be maintained to include one or an applicable combination of market groups into which the consumer is segmented, values of market segmentation variable used to segment the consumer into market groups, behaviors of the consumer in interacting with a physical retail location, and behaviors of the consumer in interacting online.

The flowchart 200 continues to module 206, where a consumer behavior-based product price of a product to offer to the consumer based on the consumer behavior-based dynamic product pricing rules and the consumer characteristics of the consumer is determined. An applicable system for targeting consumers using consumer behavior-based dynamic product pricing, such as the consumer behavior-based dynamic product pricing targeting systems described in this paper, can determine a consumer behavior-based product price of a product to offer to the consumer based on the consumer behavior-based dynamic product pricing rules and the consumer characteristics. For example, if the consumer characteristics of the consumer indicate the consumer viewed a product through an online retailer before arriving at a physical retail location and rules specify offering the product at a 10% discount to consumers who view the product before arriving at a physical retail location, then it can be determined to offer the product to the consumer at a consumer behavior-based product price of a 10% discount from a sale price of the product.

The flowchart 200 continues to module 208, where the product is offered to the consumer at the determined consumer behavior-based product price as part of targeting the consumer using consumer behavior-based dynamic product pricing. An applicable system for targeting consumers using consumer behavior-based dynamic product pricing, such as the consumer behavior-based dynamic product pricing targeting systems described in this paper, can offer or facilitate offering of the product to the consumer at the determined consumer behavior-based product price. In offering the product at the price to the consumer, the determined consumer behavior-based product price can be presented to the user, e.g. through an applicable device at a physical retail location or a dynamic pricing targeted consumer device.

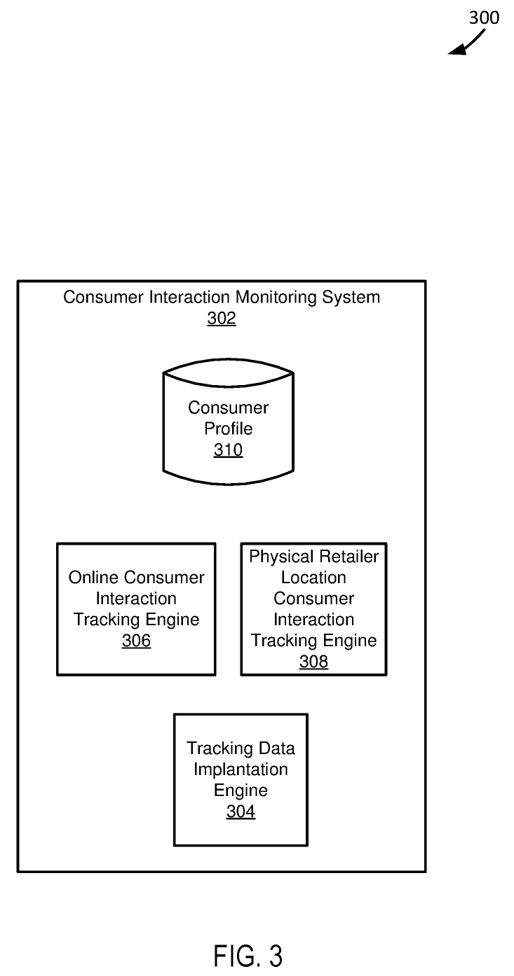

FIG. 3 depicts a diagram 300 of an example of a consumer interaction monitoring system 302. The consumer interaction monitoring system 302 is intended to represent a system that is configured to monitor consumer behaviors for use in targeting consumer using consumer behavior-based dynamic product pricing. The consumer interaction monitoring system 300 can be implemented as part of an applicable system for targeting consumers using consumer behavior-based dynamic product pricing, such as the consumer behavior-based dynamic product pricing targeting systems described in this paper. The consumer interaction monitoring system 302 can monitor behaviors of a consumer in interacting with a physical retail location. For example, the consumer interaction monitoring system 302 can determine products a consumer views while at a physical retail location. Additionally, the consumer interaction monitoring system 302 can monitor behaviors of a consumer in interacting online. For example, the consumer interaction monitoring system 302 can track webpages of a product developer a consumer visits in determining what products of the product developer the user viewed through a website of the product developer.

The example consumer interaction monitoring system 302 shown in FIG. 3 includes a tracking data implantation engine 304, an online consumer interaction tracking engine 306, a physical retailer location consumer interaction tracking engine 308, and a consumer profile datastore 310. The tracking data implantation engine 304 is intended to represent an engine that is configured to implant tracking data used in tracking online interactions of consumers. The tracking data implantation engine 304 can implant tracking data actually at a consumer device or cause an applicable system to implant tracking data at a consumer device. Online interactions monitored using tracking data implanted by the tracking data implantation engine 304 can be used in targeting consumers through consumer behavior-based dynamic product pricing. For example, if it is determined that a consumer viewed a specific product online and is therefore an informed shopper using tracking data implanted by the tracking data implantation engine 204, then a discount of 10% off the price of the product can be given the consumer at a physical retail location.

Tracking data implanted by the tracking data implantation engine 304 includes applicable data used in tracking behaviors of a consumer in interacting online. Examples of tracking data include cookies, query strings with unique session identifiers, hidden fields within web forms, and Entity Tags (“ETags”). For example, the tracking data implantation engine 304 can implant a persistent cookie into a website for use in tracking a consumer's interaction with the website. The tracking data implantation engine 304 can implant tracking data uniquely associated with a specific device or consumer to track online interactions of the consumer. For example, the tracking data implantation engine 304 can implant a persistent cookie associated with a device of a consumer for use in tracking the consumer's online interactions when utilizing the device.

In a specific implementation, the tracking data implantation engine 304 is implemented as part of an applicable retailer system or configured to cause an applicable retailer system to implant tracking data. For example, the tracking data implantation engine 304 can be implemented as part of a retailer system associated with a physical retailer location and configured to provide an online marketplace in which products are sold. In a specific implementation, the tracking data implantation engine 304 is implemented as part of an applicable product developer system or configured to cause an applicable product developer system to implant tracking data. For example, the tracking data implantation engine 304 can be implemented as part of a product developer system providing a website of the product developer and used in tracking consumer interactions when viewing products through the webpage of the product developer.

Returning back to FIG. 3, the online consumer interaction tracking engine 306 is intended to represent an engine that is configured to track behaviors of a consumer in interacting online. Behaviors tracked by the online consumer interaction tracking engine 306 can be used to target consumers through consumer behavior-based dynamic product pricing. Behaviors of a consumer in interacting online tracked by the online consumer interaction tracking engine 306 can be used to determine consumer familiarities with specific products. For example, if the online consumer interaction tracking engine 306 tracks that a consumer viewed a webpage of a consumer retailer's website indicating a description of a product, then it can be determined that the consumer is familiar with the specific product. In tracking behaviors of a consumer in interacting online, the online consumer interaction tracking engine 306 can, at least in part, profile a consumer by updating a consumer profile of the consumer to include tracked behaviors of the consumer. For example, the online consumer interaction tracking engine 306 can update a consumer profile of a consumer to include a log indicating sites a consumer viewed online, products a consumer viewed online, prices of products a consumer was offered online, products a consumer purchased online, and prices a consumer paid for purchased products.

In a specific implementation, the online consumer interaction tracking engine 306 functions to track a consumer's online interactions based on the consumer's utilization of a device in accessing network services. The online consumer interaction tracking engine 306 can monitor the flow of data to and from a consumer device utilized by a consumer in accessing network services to track the consumer's online interactions. For example, the online consumer interaction tracking engine 306 can inspect packets sent to and from a consumer device to determine systems and hosts, e.g. specific online retailers, a consumer is communicating with in accessing network services. The online consumer interaction tracking engine 306 can monitor the flow of data to and from a consumer device utilized by a consumer when the consumer is on premises at a physical retail location and accessing network services through a network provided by the physical retail location. For example, the online consumer interaction tracking engine 306 can determine which products a consumer is viewing online when the consumer is on premises at a physical retail location by analyzing the flow of data sent to and from a consumer device accessing network services through a wireless network provided by the physical retail location.

In a specific implementation, the online consumer interaction tracking engine 306 functions to track a consumer's online interactions based on data received from a consumer device used by the consumer. The online consumer interaction tracking engine 306 can track a consumer's online interactions based on data received from tracking data implanted on a consumer device. For example, a cookie implanted at a consumer device can be sent back to the online consumer interaction tracking engine 306 indicating an identifier of the cookie associated with a consumer or a consumer device and a webpage visited by the consumer. Further in the example, the online consumer interaction tracking engine 306 can maintain a log, as indicated by a consumer profile, of a webpage visited by the consumer and a timestamp at which the consumer visits the webpage based on the cookie received at the online consumer interaction tracking engine 306.

Referring back to FIG. 3, the physical retailer location consumer interaction tracking engine 308 is intended to represent an engine that functions to track consumer interactions at a physical retail location. Behaviors tracked by the physical retailer location consumer interaction tracking engine 308 can be used to target consumers through consumer behavior-based dynamic product pricing. Behaviors of a consumer in interacting at a physical retailer location tracked by the physical retailer location consumer interaction tracking engine 308 can be used to determine consumer familiarities with specific products. For example, if the physical retailer location consumer interaction tracking engine 308 tracks that a consumer viewed a demonstration of a specific product at a physical retail location, then it can be determined that the consumer is familiar with the specific product. In tracking behaviors of a consumer in interacting at a physical retail location, the physical retailer location consumer interaction tracking engine 308 can, at least in part, profile a consumer by updating a consumer profile of the consumer to include tracked behaviors of the consumer. For example, the physical retailer location consumer interaction tracking engine 308 can update a consumer profile of a consumer to include a log indicating products a consumer viewed at a physical retail location, prices of products a consumer was offered at a physical retail location, products a consumer purchased at a physical retail location, and prices a consumer paid for products at a physical retail location.

In a specific implementation, the physical retailer location consumer interaction tracking engine 308 functions to track consumer interactions at a physical retail location based on data received from applicable devices at a physical retail location. Applicable devices at a physical retail location include, a facility operator device, an advertisement presentation device at a facility, and a consumer device. For example, the physical retailer location consumer interaction tracking engine 308 can receive data from an advertisement presentation device indicating an advertisement for a specific product was displayed to a consumer. Further in the example, the physical retailer location consumer interaction tracking engine 308 can update a consumer profile of the consumer to indicate the advertisement was displayed to the consumer. In another example, the physical retailer location consumer interaction tracking engine 308 can receive data from a facility operator device indicating a facility operator showed a product to a consumer, and the physical retailer location consumer interaction tracking engine 308 can update a profile of the consumer to indicate the consumer viewed the product.

In a specific implementation, the physical retailer location consumer interaction tracking engine 308 functions to track a consumer's movements at a physical retail location in tracking the consumer's interactions at the physical retail location. The physical retailer location consumer interaction tracking engine 308 can use applicable devices at a physical retail location to tracking a consumer's movements at the physical retail location. For example, the physical retailer location consumer interaction tracking engine 308 can use cameras at a physical retail location to track a consumer's movements at the physical retail location. In another example, the physical retailer location consumer interaction tracking engine 308 can use identifications of devices a consumer interacted with at a retail location and known positions of the devices to track movements of the consumer at the retail location.

Referring back to FIG. 3, the consumer profile datastore 310 is intended to represent a datastore that functions to store consumer profile data indicating consumer profiles maintained for consumers. Consumer profile data stored in the consumer profile datastore 310 can indicate monitored behaviors of a consumer in interacting online and behaviors of a consumer in interacting at a physical retail location. Additionally, consumer profile data stored in the consumer profile datastore 310 can indicate market groups into which a consumer is segments and values of market segmentation variables for the consumer used in segmenting the consumer into the market groups.

In an example of operation of the example consumer interaction monitoring system 302 shown in FIG. 3, the tracking data implantation engine 304 functions to implant tracking data on a consumer device for purposes of tracking a consumers online interactions. In the example of operation of the example system shown in FIG. 3, the online consumer interaction tracking engine 306 uses the tracking data implanted on the consumer device to track online interactions of the consumer. Further, in the example of operation of the example system shown in FIG. 3, the online consumer interaction tracking engine 306 updates a consumer profile of the consumer, as indicated by consumer profile data stored in the consumer profile datastore 310, to indicate the tracked online interactions of the consumer. In the example of operation of the example system shown in FIG. 3, the physical retailer location consumer interaction tracking engine 308 tracks behaviors of the consumer in interacting at a physical retail location. Additionally, in the example of operation of the example system shown in FIG. 3, the physical retailer location consumer interaction tracking engine 308 updates the consumer profile data stored in the consumer profile datastore 310 to indicate the tracked behaviors of the consumer in interacting at the physical retail location.

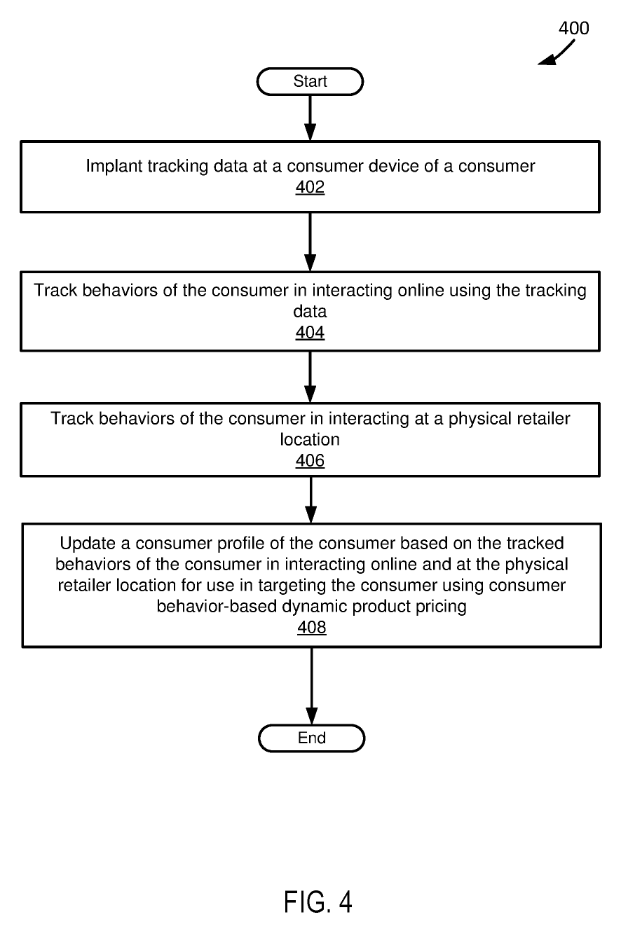

FIG. 4 depicts a flowchart 400 of an example of a method for tracking consumer behaviors for use in targeting a consumer using consumer behavior-based dynamic product pricing. The flowchart 400 begins at module 402, where tracking data is implanted at a consumer device of a consumer. An applicable engine for implanting tracking data at a consumer device for use in tracking online interactions of a consumer, such as the tracking data implantation engines described in this paper, can implant tracking data at a consumer device of a consumer. Tracking data can be implanted at a consumer device of a consumer, when the consumer accesses a website using the consumer device. For example, a cookie can be implanted at a consumer device when a consumer first views a website of a retailer.

The flowchart 400 continues to module 404, where behaviors of the consumer in interacting online are tracked using the tracking data. An applicable engine for tracking online behaviors of a consumer, such as the online consumer interaction tracking engines described in this paper, can track behaviors of the consumer in interacting online using the tracking data. For example, webpages the consumer views and times at which the consumer views the webpages can be logged using data generated and received based on the tracking data. In another example, products a consumer purchases online can be logged using data generated and received based on the tracking data.

The flowchart 400 continues to module 406, where behaviors of the consumer in interacting at a physical retail location are tracked. An applicable system for tracking behaviors of a consumer in interacting at a physical retail location, such as the physical retailer location consumer interaction tracking engines described in this paper, can track behaviors of the consumer in interacting at a physical retail location. In tracking behaviors of the consumer in interacting at a physical retail location, products the consumer views at the physical retail location can be logged. Additionally, in tracking behaviors of the consumer in interacting at a physical retail location, movements of the consumer at the physical retail location can be logged. Behaviors of the consumer in interacting at a physical retail location can be tracked based on data received from applicable devices at the physical retail location.

The flowchart 400 continues to module 408, where a consumer profile of the consumer is updated based on the tracked behaviors of the consumer in interacting online and at the physical retailer location, for use in targeting the consumer using consumer behavior-based dynamic product pricing. An applicable engine for maintaining a consumer profile, such as the online consumer interaction tracking engines and the physical retailer location consumer interaction tracking engines described in this paper, can update a consumer profile based on the tracked behaviors of the consumer in interacting online and at the physical retailer location. A consumer profile maintained at module 408 can be used to determine consumer behavior-based dynamic product pricing rules to apply in targeting the consumer using consumer behavior-based dynamic product pricing.

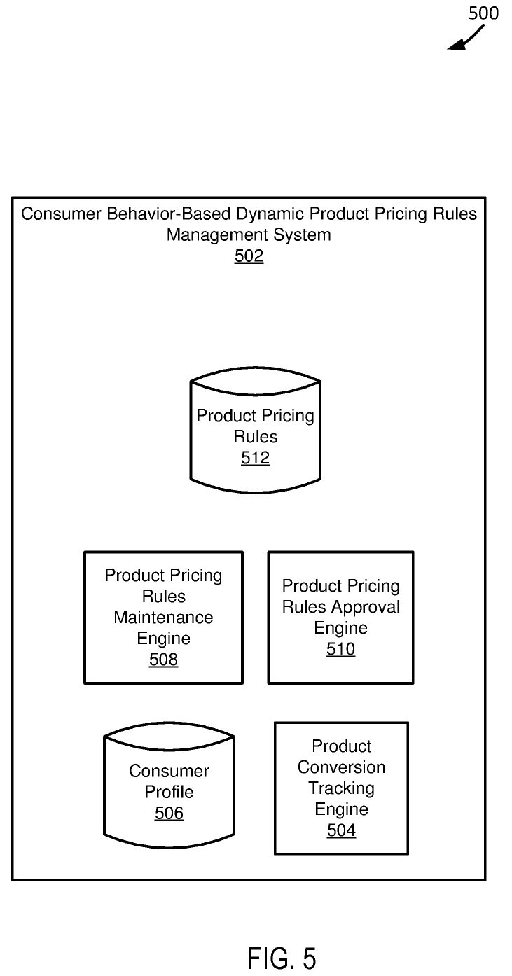

FIG. 5 depicts a diagram 500 of an example of a consumer behavior-based dynamic product pricing rules management system 502. The consumer behavior-based dynamic product pricing rules management system 502 is intended to represent a system that functions to maintain consumer behavior-based dynamic product pricing rules for use in targeting consumers using consumer behavior-based dynamic product pricing. The consumer behavior-based dynamic product pricing rules management system 502 can maintain consumer behavior-based dynamic product pricing rules based on actual conversion of products and prices offered to consumers who purchased products, e.g. through consumer behavior-based dynamic product pricing. Additionally, the consumer behavior-based dynamic product pricing rules management system 502 can maintain consumer behavior-based dynamic product pricing rules based on characteristics of consumers who actually purchased products. The consumer behavior-based dynamic product pricing rules management system 502 can be implemented as part of an applicable system for targeting customers using consumer behavior-based dynamic product pricing, such as the consumer behavior-based dynamic product pricing targeting systems described in this paper.

The consumer behavior-based dynamic product pricing rules management system 502 shown in FIG. 5 includes a product conversion tracking engine 504, a consumer profile datastore 506, a product pricing rules maintenance engine 508, a product pricing rules approval engine 510, and a product pricing rules datastore 512. The product conversion tracking engine 504 is intended to represent an engine that tracks conversion of products. In tracking conversion of products, the product conversion tracking engine 504 can determine an identification of a product sold to a consumer and an identification of a consumer. Additionally, in tracking conversion of products, the product conversion tracking engine 504 can determine prices at which products were sold, prices at which products were offered to consumer, and when products were offered to consumers. For example, the product conversion tracking engine 504 can determine a price at which a product was offered and sold to a consumer as part of consumer behavior-based dynamic product pricing. The product conversion tracking engine 504 can track product conversion based on data received from an applicable system or device. For example, the product conversion tracking engine 504 can track product conversion based on sales data received from an online retailer system. In another example, the product conversion tracking engine 504 can track product conversion based on sales data received from a facility operator device at a physical retail location.

Referring back to FIG. 5, the consumer profile datastore 506 is intended to represent an applicable datastore for storing consumer profile data, such as the consumer profile datastores described in this paper. Consumer profile data stored in the consumer profile datastore 506 can be maintained by an applicable system for profiling consumers, such as the consumer interaction monitoring systems described in this paper. Consumer profile data stored in the consumer profile datastore 506 can include behaviors of consumers in interaction online. For example, consumer profile data stored in the consumer profile datastore 506 can indicate products a consumer viewed online. Additionally, consumer profile data stored in the consumer profile datastore 506 can include behaviors of consumers in interacting at a physical retail location. For example, consumer profile data stored in the consumer profile datastore 506 can indicate products a consumer viewed at a physical retail location. Consumer profile data stored in the consumer profile datastore 506 can indicate characteristics of consumers who actually purchased a product. For example, consumer profile data stored in the consumer profile datastore 506 can indicate a market group a consumer who purchased a specific product is segmented into based on market segmentation variables.

Referring back to FIG. 5, the product pricing rules maintenance engine 508 is intended to represent an engine that functions to maintain consumer behavior-based dynamic product pricing rules. Consumer behavior-based dynamic product pricing rules maintained by the product pricing rules maintenance engine 508 can be used in targeting consumers using consumer behavior-based dynamic product pricing. The product pricing rules maintenance engine 508 can maintain product pricing rules based on tracked product conversions and consumer profiles of consumers who actually purchased products. For example, if a consumer who purchased a product viewed the product online before purchasing it and was offered a 10% discount, then the product pricing rules maintenance engine 508 can generate a product pricing rule indicating to offer a 10% discount for the product to consumers who viewed the product online. In another example, if a consumer who purchased a product lacked any prior knowledge of the product before purchasing it and was offered a 20% discount on the product when they purchased it, then the product pricing rules maintenance engine 508 can generate a product pricing rule indicating to offer a 20% discount for the product to consumers who lack any prior knowledge of the product.

In a specific implementation, the product pricing rules maintenance engine 508 functions to determine likelihoods a consumer will buy a product offered to them as part of consumer behavior-based dynamic product pricing. The product pricing rules maintenance engine 508 can used determined likelihoods a consumer will buy a product offered to them in maintaining consumer behavior-based product pricing rules. For example, if the product pricing rules maintenance engine 508 determines a consumer had prior knowledge of a product before purchasing it and was therefore more likely to purchase the product, then the product pricing rules maintenance engine 508 can generate pricing rules for the product indicating to offer an 8% discount to consumers with prior knowledge of the product. In using likelihoods of consumers buying a product in maintaining product pricing rules, the product pricing rules maintenance engine 508 can maintain rules specifying to offer a product to consumers at prices inversely proportional to likelihoods a consumer is to buy the product. For example, if a first consumer is more likely to buy a product than a second consumer, then consumer behavior-based dynamic product pricing rules generated by the product pricing rules maintenance engine 508 can specify to offer a 20% discount on the product to the second consumer and a 10% discount on the product to the first consumer.

In a specific implementation, the product pricing rules maintenance engine 508 functions to determine consumer familiarity levels with products before purchasing products offered to them as part of consumer behavior-based dynamic product pricing. The product pricing rules maintenance engine 508 can use determined consumer familiarity levels in maintaining consumer behavior-based product pricing rules. For example, if the product pricing rules maintenance engine 508 determines a consumer had prior knowledge of a product before purchasing a product and was offered an 8% discount on the product, then the product pricing rules maintenance engine 508 can maintain rules specifying to offer the product at an 8% discount to consumers with prior knowledge of the product. In using familiarity with products in maintaining product pricing rules, the product pricing rules maintenance engine 508 can maintain rules specifying to offer a product to consumers at prices inversely proportional to a familiarity level of consumers with the product. For example, the product pricing rules maintenance engine 508 can maintain product pricing rules specifying to offer a product at less of a discount to consumer who are already familiar with the product than a discount offered to consumers who are unfamiliar with the product.

In a specific implementation, the product pricing rules maintenance engine 508 functions to maintain consumer behavior-based dynamic product pricing rules based on input received from a product supplier or developer. In maintaining product pricing rules based on input from a product supplier or developer, the product pricing rules maintenance engine 508 can use input instructing specific prices of a product to offer to consumers with specific characteristics to create consumer behavior-based dynamic product pricing rules indicating to offer the product at the specific price to consumers with the specific characteristics. For example, if product developer input indicates offering a 20% discount on a product to uninformed consumers to drive product conversion, then the product pricing rules maintenance engine 508 can generate a dynamic product pricing rule to indicate offering the product at a 20% discount to uninformed consumers.

In a specific implementation, the product pricing rules maintenance engine 508 functions to maintain product pricing rules based on whether the product supplier or developer approves of a specific product pricing rules. For example, if a developer of a product does not approve of a specific product pricing rule determined by the product pricing rules maintenance engine 508, then the product pricing rules maintenance engine 508 can modify or delete the specific product pricing rule. Further in the example, in deleting the specific product pricing rule, the product pricing rules maintenance engine 508 prevents the product pricing rule from being used in targeting consumers using consumer behavior-based dynamic product pricing.

Referring back to FIG. 5, the product pricing rules approval engine 510 is intended to represent an engine that is configured to gain approval for determined consumer behavior-based dynamic product pricing rules. In gaining approval for determined consumer behavior-based dynamic product pricing rules, the product pricing rules approval engine 510 can present the rules to a product developer or supplier. For example, if a consumer behavior-based dynamic product pricing rule specify to offer a 20% discount for a specific product is generated, then the product pricing rules approval engine 510 can present the rule specifying to offer the 20% discount for the product to a developer of the product. Further, in gaining approval for determined consumer behavior-based dynamic product pricing rules, the product pricing rules approval engine 510 can receive input from a product developer or supplier indicating whether they approve of specific product pricing rules for use in targeting consumers using consumer behavior-based dynamic product pricing.

The product pricing rules datastore 512 is intended to represent a datastore that stored product pricing rules data indicating product pricing rules. Product pricing rules data stored in the product pricing rules datastore 512 indicates consumer behavior-based dynamic product pricing rules to use in targeting consumers using consumer behavior-based dynamic product pricing. Product pricing data stored in the product pricing rules datastore 512 can be maintained by an applicable engine for maintaining consumer behavior-based product pricing rules, such as the product pricing rules maintenance engines described in this paper. Product pricing rules indicated by product pricing rules data stored in the product pricing rules datastore 512 can be generated based on tracking actual conversion of products and consumer profiles of consumers who actually purchased products. Consumer behavior-based dynamic product pricing rules can be uniquely associated with a specific product or a specific type of product. For example, consumer behavior-based dynamic product pricing rules can only be used to target consumers for products of a specific type.

In an example of operation of the example consumer behavior-based dynamic product pricing rules management system 502 shown in FIG. 5, the product conversion tracking engine 504 tracks actually conversion of products. In the example of operation of the example system shown in FIG. 5, the consumer profile datastore 506 stores consumer profiles indicating characteristics of consumers who actually purchased products. Further, in the example of operation of the example system shown in FIG. 5, the product pricing rules maintenance engine 508 determines consumer behavior-based dynamic product pricing rules for products based on the tracking of the actual conversion of the products by the product conversion tracking engine 504 and the consumer profiles stored in the consumer profile datastore 506. In the example of operation of the example system shown in FIG. 5, the product pricing rules approval engine 510 gains approval from product developers of the products for the consumer behavior-based dynamic product pricing rules determined by the product pricing rules maintenance engine 508. Additionally, in the example of operation of the example system shown in FIG. 5, the product pricing rules maintenance engine 508 updates product pricing rules data stored in the product pricing rules datastore 512 to include the consumer behavior-based dynamic product pricing rules if approval is gained for the rules.

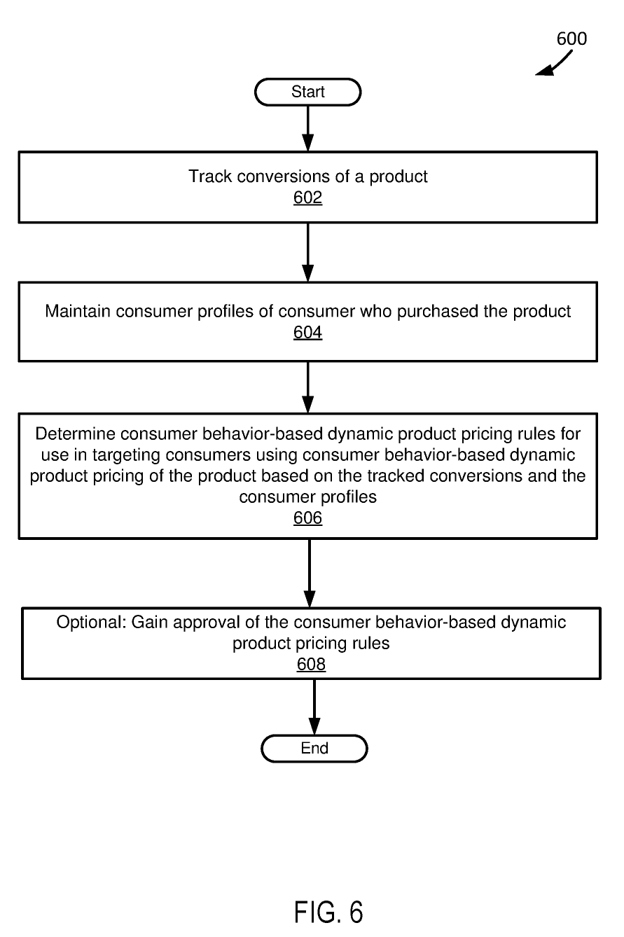

FIG. 6 depicts a flowchart 600 of an example of a method for maintaining consumer behavior-based dynamic product pricing rules for use in targeting consumers using consumer behavior-based dynamic product pricing. The flowchart 600 begins at module 602, where conversions of a product are tracked. An applicable engine for tracking product conversion, such as the product conversion tracking engines described in this paper, can track conversions of a product. Conversions of a product can be tracked through sales of the product at either or both a physical retail location and an online retail marketplace. In tracking conversions of a product, identifications of customers who bought the product and prices at which the customers bought the product can be determined.

The flowchart 600 continues to module 604, where consumer profiles of consumers who purchased the product are maintained. Consumer profiles of consumers who purchased the product can be maintained by an applicable system for maintaining consumer profiles, such as the consumer interaction monitoring systems described in this paper. Consumer profiles of consumers who purchased the product can indicate consumer characteristics of the consumers including behaviors of the consumers in interacting online and behaviors of the consumers in interacting at a physical retail location.

The flowchart 600 continues to module 606, where consumer behavior-based dynamic product pricing rules are determined based on the tracked conversions and the consumer profiles. Consumer behavior-based dynamic product pricing rules, determined at module 606, are used in targeting consumers using consumer behavior-based dynamic product pricing of the product. An applicable engine for determining consumer behavior-based product pricing rules, such as the product pricing rules maintenance engines described in this paper, can determine consumer behavior-based dynamic product pricing rules based on the tracked conversions and the consumer profiles. For example, characteristics of consumers who purchased the product and prices at which the consumers purchased the product, as part of the tracked conversions, can be used to determine consumer behavior-based dynamic product pricing rules. Consumer behavior-based dynamic product pricing rules, determined at module 606, can be uniquely associated with the product or a product type of the product and specifically used to target consumers with the product or products of the product type using consumer behavior-based dynamic product pricing.

The flowchart 600 continues to module 608, where optionally, approval of the consumer behavior-based dynamic product pricing rules is obtained. An applicable engine for gaining approval of consumer behavior-based dynamic product pricing rules, such as the product pricing rules approval engines described in this paper, can gain approval of the consumer behavior-based dynamic product pricing rules. Approval of the consumer behavior-based dynamic product pricing rules can be obtained from either or both a product developer of the product and a product supplier of the product.

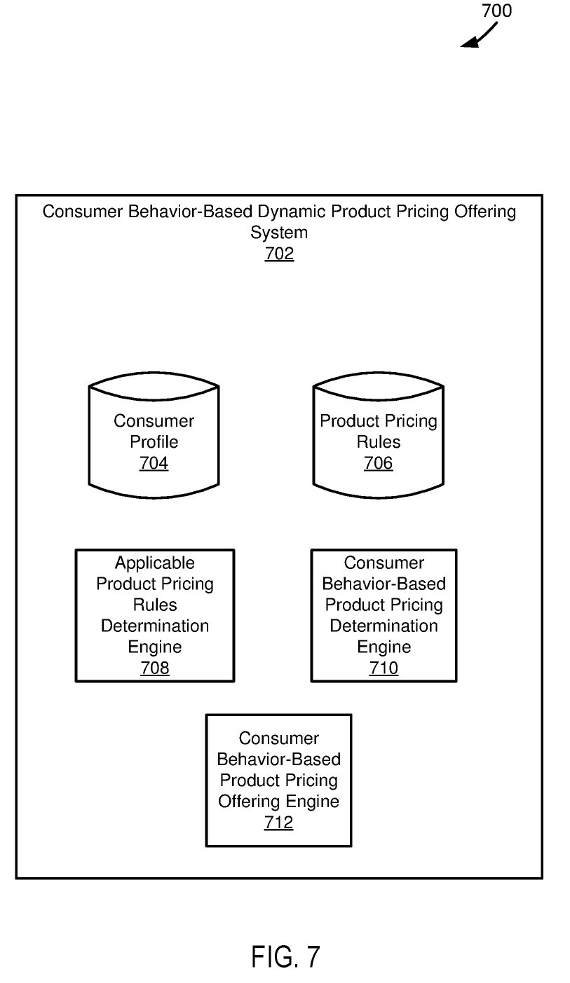

FIG. 7 depicts a diagram 700 of an example consumer behavior-based dynamic product pricing offering system 702. The consumer behavior-based dynamic product pricing offering system 702 is intended to represent a system that functions to target consumers using consumer behavior-based dynamic pricing of products. Additionally, the consumer behavior-based dynamic product pricing offering system 702 can be implemented as part of an applicable system for targeting consumers using consumer behavior-based dynamic product pricing, such as the consumer behavior-based dynamic product pricing targeting systems described in this paper.

In targeting consumers, the consumer behavior-based dynamic product pricing offering system 702 functions to determine applicable consumer behavior-based dynamic product pricing rules to apply in targeting consumers. For example, the consumer behavior-based dynamic product pricing offering system 702 can determine applicable consumer behavior-based dynamic product pricing rules based on characteristics of consumers, as indicated by consumer profiles of the consumers. Additionally, in targeting consumers, the consumer behavior-based dynamic product pricing offering system 702 can determine consumer behavior-based product prices at which to offer products according to consumer behavior-based dynamic product pricing rules. Further, in targeting consumers, the consumer behavior-based dynamic product pricing offering system 702 can offer or facilitate offering of products at determined consumer behavior-based product prices. For example, the consumer behavior-based dynamic product pricing offering system 702 can present a determined consumer behavior-based product price of a product to a consumer through a consumer device while the consumer is at a physical retail location.

The example consumer behavior-based dynamic product pricing offering system 702 shown in FIG. 7 includes a consumer profile datastore 704, a product pricing rules datastore 706, an applicable product pricing rules determination engine 708, a consumer behavior-based product pricing determination engine 710, and a consumer behavior-based product pricing offering engine 712. The consumer profile datastore 704 is intended to represent an applicable datastore for storing consumer profile data, such as the consumer profile datastores described in this paper. Consumer profile data stored in the consumer profile datastore 704 can be maintained by an applicable system for profiling consumers, such as the consumer interaction monitoring systems described in this paper. Consumer profile data stored in the consumer profile datastore 704 can include behaviors of consumers in interaction online. For example, consumer profile data stored in the consumer profile datastore 704 can indicate products a consumer viewed online. Additionally, consumer profile data stored in the consumer profile datastore 704 can include behaviors of consumers in interacting at a physical retail location. For example, consumer profile data stored in the consumer profile datastore 704 can indicate products a consumer viewed at a physical retail location. Consumer profile data stored in the consumer profile datastore 704 can indicate characteristics of consumers who actually purchased a product. For example, consumer profile data stored in the consumer profile datastore 704 can indicate a market group a consumer who purchased a specific product is segmented into based on market segmentation variables.

The product pricing rules datastore 706 is intended to represent an applicable datastore for storing product pricing rules data, such as the product pricing rules datastores described in this paper. Product pricing rules data stored in the product pricing rules datastore 706 can be maintained by an applicable engine for determining consumer behavior-based dynamic product pricing rules, such as the product pricing rules maintenance engines described in this paper. Product pricing rules data stored in the product pricing rules datastore 706 can be maintained based on characteristics of consumers who actually purchased products. Additionally, product pricing rules data stored in the product pricing rules datastore 706 can be maintained based on prices at which consumers actually purchased products. For example, if a consumer purchased a product at an 8% discount, then a consumer behavior-based dynamic product pricing rule for the product, as indicated by product pricing rules data stored in the product pricing rules datastore 706, can specify providing an 8% discount on the product to consumers with the same characteristics as the consumer.

The applicable product pricing rules determination engine 708 is intended to represent an engine that functions to determine applicable product pricing rules to apply as part of targeting customers using consumer behavior-based dynamic product pricing. The applicable product pricing rules determination engine 708 can determine applicable consumer behavior-based dynamic product pricing rules to apply for a specific consumer. In determining applicable product pricing rules to apply for a specific consumer, the applicable product pricing rules determination engine 708 can select the applicable product pricing rules based on a consumer profile of the specific consumer. For example, if consumer characteristics of a consumer, as indicated by a consumer profile, include that the consumer is knowledgeable about a specific product, then the applicable product pricing rules determination engine 708 can select consumer behavior-based dynamic product rules for consumers who are knowledgeable about the specific product.

In a specific implantation, the applicable product pricing rules determination engine 708 functions to determine applicable product pricing rules based on a specific product to offer to a consumer. For example, the applicable product pricing rules determination engine 708 can determine product pricing rules specific to a product or a product type of a product. In determining applicable product pricing rules based on a specific product to offer to a consumer, the applicable product pricing rules determination engine 708 can determine the applicable product pricing rules based on a physical location of a consumer. For example, if a consumer is at a physical retail location selling a specific product, then the applicable product pricing rules determination engine 708 can select product pricing rules specific to the product sold at the physical retail location. Additionally, in determining applicable product pricing rules based on a specific product to offer to a consumer, the applicable product pricing rules determination engine 708 can select product pricing rules based on a product or a product type a consumer has shown interest in or is knowledgeable about, as indicated by a consumer profile. For example, the applicable product pricing rules determination engine 708 can select product pricing rules specific to a product if a consumer has shown interest in the product, e.g. based on the consumer's online interactions.

Referring back to FIG. 7, the consumer behavior-based product pricing determination engine 710 is intended to represent an engine that functions to determine a consumer behavior-based product price of a dynamic consumer behavior-based product price of a product to offer to a consumer. The consumer behavior-based product pricing determination engine 710 can determine a consumer behavior-based product price at which to offer a product using applicable consumer behavior-based dynamic product pricing rules. For example, the consumer behavior-based product pricing determination engine 710 can determine a consumer behavior-based product price at which to offer a product to a consumer based on characteristics of the consumer. In determining a consumer behavior-based product price of a product to offer to a consumer, the consumer behavior-based product pricing determination engine 710 can determine a consumer behavior-based product discount to offer to a consumer. For example, the consumer behavior-based product pricing determination engine 710 can determine to offer a product to a consumer at an 8% discount, based on characteristics of the consumer.

The consumer behavior-based product pricing offering engine 712 is intended to represent an engine that functions to offer or facilitate offering a product at a determined consumer behavior-based product price to a consumer. In offering a determined consumer behavior-based product price to a consumer, the consumer behavior-based product pricing offering engine 712 can present the price to the consumer or cause the price to be presented to the consumer. For example, the consumer behavior-based product pricing offering engine 712 can cause an online retailer system to present a determined consumer behavior-based product price to a consumer. In another example, the consumer behavior-based product pricing offering engine 712 can present a determined consumer behavior-based product price of a product to a consumer through a consumer device when the consumer is at a physical retail location. In response to being presented a determined consumer behavior-based product price of a product by the consumer behavior-based product pricing offering engine 712, a consumer can choose whether to purchase the product at the presented price.

In a specific implementation, the consumer behavior-based product pricing offering engine 712 functions to retarget a consumer in presenting a determined consumer behavior-based product price of a product to the consumer. For example, the consumer behavior-based product pricing offering engine 712 can offer a product to a consumer at a determined consumer behavior-based product price at a physical retail location after the consumer is offered the product through an online retailer. In another example, the consumer behavior-based product pricing offering engine 712 can offer a product to a consumer at a determined consumer behavior-based product price through an online retailer after the consumer is offered the product at a physical retail location.

In a specific implementation, the consumer behavior-based product pricing offering engine 712 functions to present a determined consumer behavior-based product price of a product to a consumer with an expiration time of the price. For example, the consumer behavior-based product pricing offering engine 712 can present to a consumer an indication that a determined consumer behavior-based product price will expire in twenty-four hours if the consumer fails to purchase the product at the determined price. The consumer behavior-based product pricing offering engine 712 can present an expiration time of a consumer behavior-based product price to a consumer, wherein the expiration time is determined according to consumer behavior-based dynamic product pricing rules.

In a specific implementation, the consumer behavior-based product pricing offering engine 712 functions to instruct an applicable conversion payment system to process payment of a product at a presented consumer behavior-based product price. For example, the consumer behavior-based product pricing offering engine 712 can instruct a facility operator device at a physical retail location to process conversion of a product at an offered consumer behavior-based product price if a consumer accepts the offer. In another example, the consumer behavior-based can instruct an online realtor to process conversion of a product at an offered consumer behavior-based product price if a consumer accepts the offer.

In an example of operation of the example consumer behavior-based dynamic product pricing offering system 702 shown in FIG. 7, the consumer profile datastore 704 stores consumer profile data indicating characteristics of a consumer. In the example of operation of the example system shown in FIG. 7, the product pricing rules datastore 706 stores product pricing rules data indicating consumer behavior-based dynamic product pricing rules to utilize in targeting the consumer using consumer behavior-based dynamic product pricing of the product. Further, in the example of operation of the example system shown in FIG. 7, the applicable product pricing rules determination engine 708 determines applicable consumer behavior-based dynamic product pricing rules based on the consumer profile indicated by the consumer profile data stored in the consumer profile datastore 704.

In the example of operation of the example system shown in FIG. 7, the consumer behavior-based product pricing determination engine 710 determines a consumer behavior-based product price of a dynamic consumer behavior-based product price to offer a product to the consumer based on the determined applicable consumer behavior-based dynamic product pricing rules. Additionally, in the example of operation of the example system shown in FIG. 7, the consumer behavior-based product pricing offering engine 712, presents the consumer behavior-based product price for the product the consumer, for use in causing selling the product to the consumer as part of targeting the consumer using consumer behavior-based dynamic product pricing.

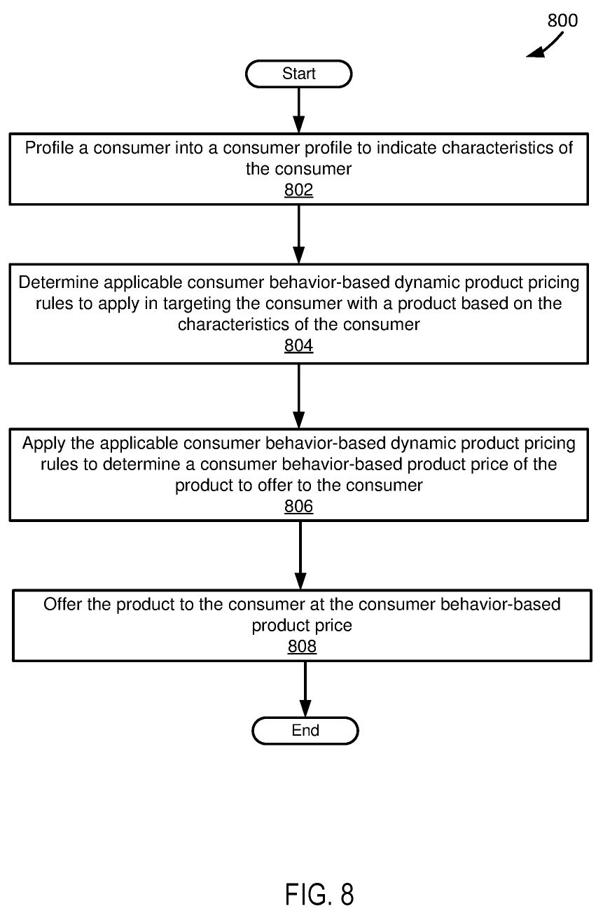

FIG. 8 depicts a flowchart 800 of an example of a method of presenting consumer behavior-based product prices of products determined according to consumer behavior-based dynamic product pricing rules to a consumer. The flowchart 800 begins at module 802, where a consumer is profiled into a consumer profile to indicate characteristics of the consumer. An applicable system for profiling a consumer, such as the consumer interaction monitoring systems described in this paper, can profile a consumer into a consumer profile to indicate characteristics of the consumer. A consumer can be profiled into a consumer profile based on behaviors of the consumer in interacting online. For example, a consumer can be profiled into a consumer profile based on products the consumer viewed online. Additionally, a consumer can be profiled into a consumer profile based on behaviors of the consumer in interacting at a physical retail location. For example, a consumer can be profiled into a consumer profile based on products a consumer viewed at a physical retail location.

The flowchart 800 continues to module 804, where applicable consumer behavior-based dynamic product pricing rules to apply in targeting the consumer with a product are determined based on the characteristics of the consumer. An applicable engine for determining consumer behavior-based dynamic product pricing rules, such as the applicable product pricing rules determination engines described in this paper, an determine applicable consumer behavior-based dynamic product pricing rules to apply in targeting the consumer with a product. For example if a consumer is knowledgeable about a specific product, then consumer behavior-based dynamic product pricing rules for targeting a consumer who is knowledgeable about a specific product can be selected.

The flowchart 800 continues to module 806, where the applicable consumer behavior-based dynamic product pricing rules are applied to determine a consumer behavior-based product price of the product to offer to the customer. An applicable engine for applying consumer behavior-based dynamic product pricing rules, such as the consumer behavior-based product pricing determination engines described in this paper, can apply the applicable consumer behavior-based dynamic product pricing rules to determine a consumer behavior-based product price of the product to offer to the customer. In applying the applicable consumer behavior-based dynamic product pricing rules, a consumer behavior-based product price of a dynamic consumer behavior-based product price of the produce can be determined.

The flowchart 800 continues to module 808, where the product is offered to the consumer at the consumer behavior-based product price. An applicable engine for offering products to a consumer, such as the consumer behavior-based product price offering engines described in this paper, can offer the product to the consumer at consumer behavior-based product price. In offering the product to the consumer at the consumer behavior-based product price, an applicable system can be instructed to offer the product at the determined consumer behavior-based product price. For example, an online retailer system can be instructed to present the consumer behavior-based product price to a consumer.

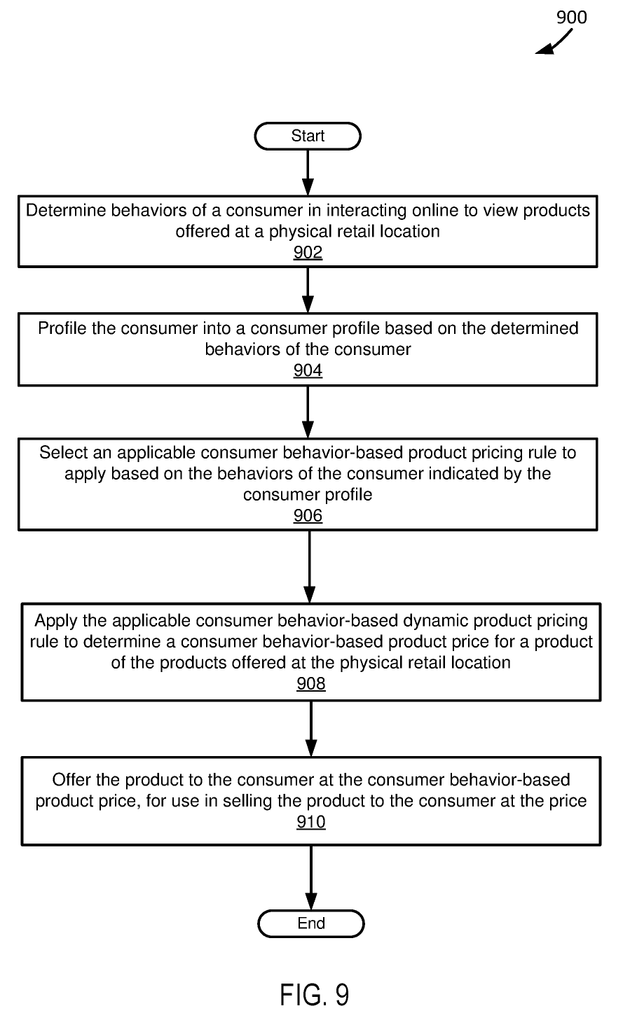

FIG. 9 depicts a flowchart 900 of an example of a method for targeting a consumer using consumer behavior-based dynamic product pricing. The flowchart 900 begins at module 902, where behaviors of a consumer in interacting online to view products offered at a physical retail location are determined. An applicable engine for tracking behaviors of a consumer in interacting online, such as the online consumer interaction tracking engines described in this paper, can determine behaviors of a consumer in interacting online to view products offered at a physical retail location. Behaviors of a consumer in interacting online can be monitored using tracking data implanted at a consumer device of the consumer.

The flowchart 900 continues to module 904, where the consumer is profiled into a consumer profile based on the determined behaviors of the consumer. An applicable engine for profiling a consumer based on behaviors of a consumer in interacting online, such as the online consumer interaction tracking engines described in this paper, can profile the consumer into a consumer profile based on the determined behaviors of the consumer. The consumer can be profiled into the consumer profile based on the behaviors of the consumer in interacting online to view products offered at the physical retail location. Additionally, the consumer can be profiled into a consumer profile based on behaviors of the consumer in interacting at the physical retail location.

The flowchart 900 continues to module 906, where an applicable consumer behavior-based product pricing rule to apply is selected based on the behaviors of the consumer indicated by the consumer profile. An applicable engine for selecting an applicable consumer behavior-based product pricing rule, such as the applicable product pricing rules determination engines described in this paper, can select an applicable consumer behavior-based product pricing rule based on the behaviors of the consumer indicated by the consumer profile. An applicable consumer behavior-based product pricing rule to apply can be selected based on a familiarity of the consumer with the products offered at the physical retail location, as indicated by the behaviors of the consumer in interacting online to view the products.

The flowchart 900 continues to module 908, where the applicable consumer behavior-based dynamic product pricing rule is applied to determine a consumer behavior-based product price for a product of the products offered at the physical retail location. An applicable engine for applying consumer behavior-based dynamic product pricing rules to determine product prices for products, such as the consumer behavior-based product pricing determination engines described in this paper, can apply the applicable consumer behavior-based dynamic product pricing rule to determine a consumer behavior-bad product price for a product of the products offered at the physical retail location. A consumer behavior-based product price for a product determined through application of the applicable consumer behavior-based dynamic product pricing rule can be part of a dynamic consumer behavior-based product price for the product.

The flowchart 900 continues to module 910, where the product is offered to the consumer at the consumer behavior-based product price, for use in selling the product to the consumer at the price. An applicable engine for offering a product to a user at a determined consumer behavior-based product price, such as the consumer behavior-based product pricing offering engines described in this paper, can offer the product to the consumer at the determined consumer behavior-based product price. The product can be offered to the consumer at the determined consumer behavior-based product price as part of targeting the consumer using consumer behavior-based dynamic product pricing.

These and other examples provided in this paper are intended to illustrate but not necessarily to limit the described implementation. As used herein, the term “implementation” means an implementation that serves to illustrate by way of example but not limitation. The techniques described in the preceding text and figures can be mixed and matched as circumstances demand to produce alternative implementations.

We claim:

1. A method comprising:
determining behaviors of a consumer in interacting online to view products offered at a physical retail location;
profiling the consumer into a consumer profile based on the behaviors of the consumer in interacting online to view the products offered at the physical retail location;
selecting an applicable consumer behavior-based dynamic product pricing rule to apply based on the behaviors of the consumer as indicated by the consumer profile;
applying the applicable consumer behavior-based dynamic product pricing rule to determine a consumer behavior-based product price of a dynamic consumer behavior-based product price for a product of the products offered at the physical retail location;
offering the product to the consumer at the consumer behavior-based product price, for use in selling the product to the consumer as part of targeting the consumer using consumer behavior-based dynamic product pricing.

2. The method of claim 1, wherein the product is offered to the consumer while the consumer is at the physical retail location.

3. The method of claim 1, wherein product is offered to the consumer through an online retailer marketplace.

4. The method of claim 1, wherein the products offered at the physical retail location are offered according to a flash retailing model.

5. The method of claim 1, further comprising:
determining behaviors of the consumer in interacting at the physical retail location;
profiling the consumer into the consumer profile based on the behaviors of the consumer in interacting at the physical retail location;
selecting the applicable consumer behavior-based dynamic product pricing rule based on the behaviors of the consumer in interacting at the physical retail location;
applying the applicable consumer behavior-based dynamic product pricing rule to determine the consumer behavior-based product price for the product offered at the physical retail location based on the behaviors of the consumer in interacting at the physical retail location;
offering the product to the consumer at the consumer behavior-based product price determined based on the behaviors of the consumer in interacting at the physical retail location.

6. The method of claim 1, wherein the applicable consumer behavior-based dynamic pricing rule is selected from a plurality of consumer behavior-based dynamic pricing rules inversely proportional to consumer familiarity with the products offered at the physical retail location.

7. The method of claim 1, further comprising:
implanting tracking data at a consumer device of the consumer;
using the implanted tracking data to determine the behaviors of the consumer in interacting online to view the products offered at the physical retail location.

8. The method of claim 1, further comprising:
implanting tracking data at a consumer device of the consumer when the consumer uses the consumer device to view the products offered at the physical retail location through an online retail marketplace associated with the physical retail location;
using the implanted tracking data to determine the behaviors of the consumer in interacting online to view the products offered at the physical retail location.

9. The method of claim 1, further comprising:
tracking actual product conversions of the product to consumers;
profiling the consumers that purchased the product;
creating the applicable consumer behavior-based dynamic product pricing rules based on the tracking of the actual product conversions and the profiling of the consumer that purchased the product.

10. The method of claim 1, further comprising instructing a facility operator device at the physical retail location to accept the consumer behavior-based product price for the consumer if the consumer accepts the consumer behavior-based product price for the product at the physical retail location.

11. A system comprising:
an online consumer interaction tracking engine configured to:
determine behaviors of a consumer in interacting online to view products offered at a physical retail location;
profile the consumer into a consumer profile based on the behaviors of the consumer in interacting online to view the products offered at the physical retail location;
an applicable product pricing rules determination engine configured to select an applicable consumer behavior-based dynamic product pricing rule to apply based on the behaviors of the consumer as indicated by the consumer profile;
a consumer behavior-based product pricing determination engine configured to apply the applicable consumer behavior-based dynamic product pricing rule to determine a consumer behavior-based product price of a dynamic consumer behavior-based product price for a product of the products offered at the physical retail location;
a consumer behavior-based product pricing offering engine configured to offer the product to the consumer at the consumer behavior-based product price, for use in selling the product to the consumer as part of targeting the consumer using consumer behavior-based dynamic product pricing.

12. The system of claim 11, wherein the consumer behavior-based product pricing offering engine is further configured to offer the product to the consumer while the consumer is at the physical retail location.

13. The system of claim 11, wherein the consumer behavior-based product pricing offering engine is further configured to offer the product the consumer through an online retailer marketplace.

14. The system of claim 11, wherein the products offered at the physical retail location are offered according to a flash retailing model.

15. The system of claim 11, further comprising:
a physical retailer location consumer tracking engine configured to:
determine behaviors of the consumer in interacting at the physical retail location;
profile the consumer into the consumer profile based on the behaviors of the consumer in interacting at the physical retail location;
the applicable product pricing rules determination engine further configured to select the applicable consumer behavior-based dynamic product pricing rule based on the behaviors of the consumer in interacting at the physical retail location;
the consumer behavior-based product pricing determination engine further configured to apply the applicable consumer behavior-based dynamic product pricing rule to determine the consumer behavior-based product price for the product offered at the physical retail location based on the behaviors of the consumer in interacting at the physical retail location;
the consumer behavior-based product pricing offering engine further configured to offer the product to the consumer at the consumer behavior-based product price determined based on the behaviors of the consumer in interacting at the physical retail location.

16. The system of claim 11, wherein the applicable product pricing rule determination engine is further configured to select the applicable consumer behavior-based dynamic pricing rule from a plurality of consumer behavior-based dynamic pricing rules inversely proportional to consumer familiarity with the products offered at the physical retail location.

17. The system of claim 11, further comprising:
a tracking data implantation engine configured to implant tracking data at a consumer device of the consumer;
the online consumer interaction tracking engine further configured to use the implanted tracking data to determine the behaviors of the consumer in interacting online to view the products offered at the physical retail location.

18. The system of claim 11, further comprising:
a tracking data implantation engine configured to implant tracking data at a consumer device of the consumer when the consumer uses the consumer device to view the products offered at the physical retail location through an online retail marketplace associated with the physical retail location;
the online consumer interaction tracking engine further configured to use the implanted tracking data to determine the behaviors of the consumer in interacting online to view the products offered at the physical retail location.

19. The system of claim 11, further comprising:
a product conversion tracking engine configured to track actual product conversions of the product to consumers;
a consumer interaction monitoring system configured to profile the consumers that purchased the product;
a product pricing rules maintenance engine configured to create the applicable consumer behavior-based dynamic product pricing rules based on the tracking of the actual product conversions and the profiling of the consumer that purchased the product.

20. A system comprising:
means for determining behaviors of a consumer in interacting online to view products offered at a physical retail location;
means for profiling the consumer into a consumer profile based on the behaviors of the consumer in interacting online to view the products offered at the physical retail location;
means for selecting an applicable consumer behavior-based dynamic product pricing rule to apply based on the behaviors of the consumer as indicated by the consumer profile;
means for applying the applicable consumer behavior-based dynamic product pricing rule to determine a consumer behavior-based product price of a dynamic consumer behavior-based product price for a product of the products offered at the physical retail location;
means for offering the product to the consumer at the consumer behavior-based product price, for use in selling the product to the consumer as part of targeting the consumer using consumer behavior-based dynamic product pricing.
